(19) United States
(12) Patent Application Publication
(10) Pub. No.: US 2010/0182698 A1
(43) Pub. Date: Jul. 22, 2010

(54) Security Documents with Personalised Images and Methods of Manufacture

(75) Inventors: Joshua Robert Nemeth, Victoria (AU); Gary Fairless Power, Victoria (AU); Robert Stewart, Cumbria (GB)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: SECURENCY INTERNATIONAL PTY. LTD., Craigieburn, Victoria (AU)

(21) Appl. No.: 12/161,043

(22) PCT Filed: Jan. 16, 2007
(86) PCT No.: PCT/AU2007/000037

§ 371 Date: Mar. 17, 2010

(30) Foreign Application Priority Data
Jan. 16, 2006 (AU) 2006900202

(51) Int. Cl. B42D 15/10; G02B 5/18; B05D 5/06; B05D 3/06; B05D 3/12; C25F 3/00

(52) U.S. Cl. 359/576; 427/162; 427/555; 205/640

(57) ABSTRACT

A method of producing a personalized security document or article includes providing a substrate which is transparent at least to visible light. A diffractive optical microstructure is formed in a substantially opaque layer disposed on a surface of the substrate. The diffractive structure comprises a plurality of apertures formed in the opaque layer, such that when the structure is suitably illuminated, for example by a beam of collimated light, a projected image is generated which is unique to a particular individual. Also, personalized security documents or articles made in accordance with the method.

### FIELD OF THE INVENTION

The present invention relates generally to methods of producing security documents or similar articles and, in particular, security documents or other articles which include optically diffractive structures. The invention is particularly useful for the production of documents and/or articles bearing individually personalised diffractive structures, but the various methods described herein may be used to produce optically diffractive structures bearing images other than personalised images.

### BACKGROUND OF THE INVENTION

It is known to apply diffraction gratings and similar optically-detectable microstructures to security documents or similar articles, such as identity cards, passports, credit cards, bank notes, cheques and the like. Such microstructures have the advantages of being difficult to falsify or modify, and being easily destroyed or damaged by any attempts made to tamper with the document. Accordingly, such optically-detectable structures may be used to provide an effective security feature.

One common method of applying predetermined diffraction gratings and similar structures to security documents involves the use of multi-layer thin films. The thin-film devices are typically supported on a carrier structure during production, and then transferred from the carrier substrate to the security document or other article, typically by using a hot stamping process.

An alternative method of producing optically-detectable structured devices involves the exposure of a substrate to laser radiation via a mask suitably formed so as to create a patterned beam of light corresponding with the desired structure. According to this method, the substrate is transparent to visible light, but absorbs light at the wavelength of the laser, such that the exposure of the substrate to the patterned light results in ablation of the surface to form a corresponding three dimensional optically diffractive structure thereon.

The above described methods are particularly well suited to the mass production of multiple copies of a single diffractive structure. In the case of thin-film devices, multiple copies of the device may be produced on a sheet or tape, for subsequent transfer to security documents or other articles. Alternatively, a single mask may be used multiple times to generate identical diffractive structures by laser writing. Accordingly, these methods are most useful when producing security documents or other articles bearing a common diffractive element as a security feature, such as a hologram or other structure unique to the manufacturer or issuer of the document.

However, the prior art methods are generally less well suited to the production of individualised diffractive structures, such as structures that are unique to each particular individual holder of a given type of security document, eg a credit card, identification pass, passport and so forth. In this case, each document must be uniquely personalised, and mass production techniques which make the use of thin-film devices and/or mask written structures particularly attractive are no longer cost effective, due to the time and expense involved in creating the thin films and/or mask structures in the first place.

Accordingly, it is desirable to provide more cost effective methods of producing individually personalised or otherwise unique diffractive optical microstructures in security documents or similar articles.

### SUMMARY OF THE INVENTION

In one aspect, the present invention provides a method of producing a personalised security document or article, including the steps of:

providing a substrate which is transparent at least to visible light; and

forming a diffractive optical microstructure comprising a plurality of apertures formed in a substantially opaque layer disposed on a surface of the substrate,

wherein the diffractive optical microstructure is formed such that when suitably illuminated a projected image is generated which is unique to a particular individual.

In various embodiments of the invention, a variety of different approaches may be taken for forming the diffractive optical microstructure in the opaque layer. In one general class of processes according to embodiments of the invention, at least one layer is applied to the substrate, and the diffractive optical microstructure is formed by ablation of this layer. Additional layers may be applied to the substrate either before or after ablation, ie the diffractive optical microstructure may be formed in a surface layer, or in an internal layer of a plurality of layers applied to the substrate.

A personalised diffractive optical microstructure formed in accordance with the invention relies upon the effect produced when collimated light, eg from a point light source or a laser, that is incident upon the structure passes through, and is diffracted by, the ablated portions formed in the surface layer. An interference pattern may thereby be generated which produces an image that is visible when projected onto a suitable viewing surface or when the diffractive optical microstructure is viewed in transmission using a point light source.

The present invention is particularly applicable to the formation of diffractive microstructures known as numerical-type diffractive optical elements (DOEs). The simplest numerical-type DOEs rely on the mapping of complex data that reconstruct in the far field (or reconstruction plane) a two-dimensional intensity pattern. Thus when substantially collimated light, eg from a point light source or a laser, is incident upon the DOE, an interference pattern is generated that produces a projected image in the reconstruction plane that is visible when a suitable viewing surface is located in the reconstruction plane or when the DOE is viewed in transmission at the reconstruction plane. The transformation between the two planes can be approximated by a fast Fourier transform (FFT). Thus, complex data including amplitude and phase information has to be physically encoded in the microstructure of the DOE. This DOE data can be calculated by performing an inverse FFT transformation of the desired reconstruction (ie the desired intensity pattern in the far field).

In some embodiments of the invention, at least one opacifying layer is applied to the substrate, whereby a transmissive diffractive optical microstructure is formed by ablation of apertures in the opacifying layer.

Furthermore, in accordance with embodiments of the invention various means and methods may be employed to ablate a substantially opaque layer disposed on a surface of the substrate.

One general ablation process applicable to embodiments of the invention is laser ablation, involving the exposure of one or more areas of the substantially opaque layer to ablate apertures therein. According to preferred embodiments, laser ablation may be performed by direct laser scanning of the desired personalised diffractive optical microstructure onto the opaque layer. Advantageously, direct laser scanning includes the individualised control of a laser beam, such as by the use of computer numerical control (CNC), in order to form an individual or unique optical microstructure.

Alternatively, laser ablation may be performed by first forming a personalised mask corresponding with the desired personalised diffractive optical microstructure using appropriate methods in accordance with embodiments of the invention, and then exposing the opaque layer to laser radiation directed through the mask. The mask may be designed such that the layer is exposed in the near field to laser radiation directed through the mask, whereby the mask includes apertures substantially formed in the shape of the desired areas to be ablated. Alternatively, the mask may be designed such that the layer is exposed in the far field to laser radiation directed through the mask, whereby the mask includes apertures formed to produce a diffraction pattern corresponding with the shape of the desired areas to be ablated.

Advantageously, the mask may be manufactured to a larger scale then the desired personalised diffractive optical microstructure, which is subsequently created by exposure of the substrate or layer applied thereto by reducing optics, such as a suitable lens arrangement. Advantageously, this approach increases the required minimum feature size of the mask, thereby enabling the use of lower precision equipment for the formation of the mask. Furthermore, the mask may be generated in cheap materials, such as aluminium coated polypropylene. In addition, the durability of the mask may be improved due to the reduced required optical power density instant upon the mask. All of the aforementioned factors may reduce the cost and complexity of mask production, thereby enabling individually personalised masks to be produced for use in forming corresponding personalised diffractive optical microstructures within acceptable timeframes and at acceptable costs.

In this regard, masks may generally be made by a variety of methods, including, but not limited to, the various techniques disclosed herein for forming optical structures in opaque layers disposed on the surface of transparent substrates.

In particularly preferred embodiments, the method involves generating a personalised mask in parallel with the manufacture of other features and elements of the security document or article, thereby further reducing the overall time required to manufacture the final personalised security document or article.

According to one preferred method in accordance with the invention, the desired personalised diffractive optical microstructure is represented as an array of discrete elements. In a particularly preferred embodiment, the diffractive optical microstructure is represented as a two dimensional field having predetermined dimensions, and the method includes:

subdividing the two dimensional field into an array of discrete elements; and

determining the content of each discrete element of the field in order to form an image of the diffractive optical microstructure.

Each discrete element may be a square or rectangular pixel, and accordingly the image formed of the diffractive optical microstructure may be a bitmap image. The resulting image may be used for direct laser scanning of the opaque layer, for example using an XY galvanometer or a CNC stage to scan a laser over the substrate whereby the laser is activated to ablate points of the opaque layer corresponding with discrete elements or pixels of the image. The laser used for this process may be, for example, a frequency tripled or quadrupled Nd:YAG system with a telecentric scanning head, providing a pixel size of typically 7 microns. Alternatively, a CNC stage may be used in conjunction with a frequency doubled Nd:YAG laser, providing typically a smaller pixel size of 5 microns or less.

In other embodiments, instead of representing the diffractive optical microstructure as an array of discrete elements, the microstructure may be represented as a plurality of narrow tracks. According to methods of this type, each track is sufficiently narrow to cause diffraction of light passing therethrough. The tracks may be straight, curved or of arbitrary shape in accordance with the requirements of the desired diffractive optical microstructure. The method may then include:

generating a diffractive optical microstructure mask image; and
converting the diffractive optical microstructure mask image into a plurality of vectors corresponding with the narrow tracks. This conversion to form a representation of the diffractive optical microstructure as a plurality of narrow tracks may be performed digitally upon a bitmap image of the diffractive optical microstructure mask using image analysis techniques known in the art.

A particular advantage of embodiments based upon a diffractive optical microstructure represented as a plurality of narrow tracks is that a laser having a relatively large spot size may be used to generate the corresponding mask. For example, track widths of 20 to 25 microns may be used to produce diffractive optical microstructures substantially equivalent to those produced from bitmap images having a pixel size of around 10 microns. As with previously described embodiments, direct laser scanning using an XY galvanometer or a CNC stage may be used to generate a suitable mask from the representation based upon a plurality of narrow tracks.

In still further embodiments, the diffractive optical microstructure may be represented as a tiled array of square or rectangular sub-regions, each corresponding with, for example, a group of pixels. In preferred embodiments, each sub-region may correspond with an area of around 10 to 20 pixels wide by 10 to 20 pixels high. Preferably, each sub-region is approximated by one of a predetermined plurality of masks, each mask defining a fixed graphical form, for example, a curve, a vertical line, a horizontal line, and/or a line arranged along a diagonal or at any arbitrary angle relative to the sub region.

A desired personalised diffractive optical microstructure, or a mask for forming such a diffractive optical microstructure, may then be constructed by exposing sub-regions of the opaque layer to laser radiation through corresponding masks selected from the predetermined plurality of masks.

In a representative embodiment, a library of around 100 masks or fewer may be provided representing various possible configurations of each square or rectangular sub-region of the tiled array representing the diffractive optical microstructure. In a particularly convenient arrangement, the library of masks may be formed on a single plate, such as a quartz mask plate, positionable to expose the corresponding sub-regions of the representation in accordance with the desired diffractive optical microstructure. Advantageously, embodiments of the invention based upon representing the diffractive optical microstructure as a tiled array of sub-regions may result in a considerable reduction in the formation time of the microstructure, by comparison with individual pixel writing methods. For example, a 4 to 16 million pixel mask may be reduced to only 20,000 sub regions which, at 200 Hz, may be formed in around 100 seconds.

In yet further embodiments, a personalised diffractive optical microstructure may be formed by direct imaging including the step of directing a laser beam onto the opaque layer using a micro-mirror array. Such an array may consist of a very large number, for example millions, of individual micro-mirrors, each of which may be controlled electronically in order to direct the reflective face of the mirror at a desired angle. In preferred embodiments, the angle of each mirror is set either to direct light onto, or away from, the opaque layer, in order to generate a pattern of illumination corresponding with the diffractive optical microstructure to be formed therein.

In one advantageous arrangement, the light directed away from the opaque layer by the mirrors may be directed at a second target, such as a further similar substrate, in order to generate a second identical diffractive optical microstructure on the second target using the same laser pulse. As will be appreciated by those skilled in the art, the inverse of a mask for forming a diffractive optical microstructure produces a structure having identical optical imaging properties to the original, uninverted, mask.

In variations of this method, multiple smaller beams may be used in combination with smaller and simpler micro mirror arrays in order to generate a diffractive optical microstructure using patterns of interference between said beams.

Yet another alternative method of producing a personalised diffractive optical microstructure includes providing at least two masks, each of which may again be selected from a library of masks, each thereby corresponding with a predetermined diffractive element. The step of forming the diffractive optical microstructure in the opaque layer may then include exposing the layer to laser radiation directed through each one of said masks. In accordance with this method, a diffractive optical microstructure is produced which is a superposition of the diffractive elements corresponding with the masks. When suitably illuminated, such as with a substantially collimated beam of light, an image is generated which includes sub-images corresponding with each of the constituent diffractive elements. Accordingly, personalised diffractive optical microstructures may be formed from unique combinations of selected masks, or from combinations of masks that are specific to a particular individual. For example, a library of masks corresponding with generated images of alphanumeric characters may be provided, and diffractive optical microstructures formed from superimposed combinations of two such masks, corresponding with the initials of a particular individual. The superposition of diffractive elements may be performed, in various embodiments, either by simultaneous or sequential exposure of the opaque layer to laser radiation directed through the masks.

In still further embodiments of the invention, methods other than direct laser writing may be used to form personalised diffractive optical microstructures and/or to form masks suitable for the creation of diffractive optical microstructures by laser writing methods.

For example, according to one such embodiment a personalised diffractive optical microstructure or a mask may be formed by printing the required pattern onto a suitable transparent substrate. Preferably, a printing technique is employed that is capable of providing a true resolution of 5,000 dpi, thereby producing printed pixels on the mask having dimensions of around 5 microns. It will be appreciated that the term “true resolution” is intended to refer to the actual pixel size, and not to the density of ink spots printed, to which the specification of printing resolution often relates. That is, printing techniques compatible with embodiments of the invention must deposit toner or ink elements of a sufficiently smaller size for the formation of a diffractive optical microstructure mask, and not merely provide printed elements of a high density.

In further embodiments of the invention, a direct mechanical process may be used to form a diffractive optical microstructure and/or a mask for the production of a diffractive optical microstructure. According to some embodiments of this type, a CNC stage may be fitted with one or more mechanical ablating structures, such as needles, which may be used to selectively physically remove layers of opaque coating from a substrate, such as by scraping. Layers may be mechanically removed in this manner from the substrate itself, or from a photoresist or other layer disposed on the surface of the substrate for this purpose. According to preferred embodiments, a diffractive optical microstructure of a corresponding mask is thereby formed through the operation of an XY scanning system controlling the needles in order to mechanically ablate individual elements or pixels, or alternatively to ablate narrow tracks or vectors.

Yet further embodiments of the invention may employ electro-chemical machining for the formation of diffractive optical microstructures and/or masks for use in the production of diffractive optical microstructures. According to a method of electro-chemical machining, portions of a metal layer are removed from a substrate using an electrical current in a suitable salt solution. An electrode is preferably provided which is shaped to correspond with the areas of the metal layer that are to be removed from the substrate. According to one embodiment, a reconfigurable electrode is formed as an array of individual electrode elements, such as pins, selectably extensible or retractable to generate a desired diffractive optical microstructure pattern, in the manner of an array of pixels. Such an electrode may be used to form a desired pattern, and to image the pattern onto metalised quartz or polymer, whereby the resulting mask may be used for the formation of a diffractive optical microstructure using laser writing techniques.

As will be appreciated from the foregoing summary, methods in accordance with the present invention provide practical time and cost effective processes for the formation of individually personalised diffractive optical microstructures on personalised security documents and/or other articles. In accordance with the invention, limitations of the prior art whereby it is generally practical only to mass produce predetermined diffractive optical micro structures are mitigated, thereby enabling the practical realisation of unique, personalised secure documents.

In another aspect, the present invention provides a personalised security document or article which includes:

a substrate which is transparent at least to visible light; and

a diffractive optical microstructure formed in a substantially opaque layer disposed on a surface of the substrate using a method in accordance with the aforedescribed aspect of the invention.

In still another aspect, the invention provides a personalised security document or article which includes:

a substrate which is transparent at least to visible light; and

a diffractive optical microstructure comprising a plurality of apertures formed in a substantially opaque layer disposed on a surface of the substrate,

wherein the diffractive optical microstructure is formed such that when suitably illuminated an image is generated which is unique to a particular individual.

In another aspect, the present invention provides a method of producing a security document or article including a substrate transparent to at least visible light and a diffractive optical microstructure, the method including the steps of:

representing the diffractive optical microstructure as a plurality of narrow tracks, and

forming the diffractive optical microstructure in a substantially opaque layer disposed on a surface of the substrate, by forming apertures in said layer in accordance with the plurality of narrow tracks.

In yet another aspect, the present invention provides a method of producing a security document or article including a substrate transparent to at least visible light and a diffractive optical microstructure, the method including the steps of:

representing the diffractive optical microstructure as a tiled array of square or rectangular sub-regions; and

forming the diffractive optical microstructure in a substantially opaque layer disposed on a surface of the substrate by forming apertures in said layer corresponding with said array of square or rectangular sub-regions.

In another aspect, the present invention provides a method of producing a security document or article including a substrate transparent to at least visible light and a diffractive optical microstructure, the method including the steps of:

representing the diffractive optical microstructure as a two-dimensional array of discrete elements; and

forming the diffractive optical microstructure by ablation of apertures in a substantially opaque layer disposed on a surface of the substrate,

wherein the step of forming the diffractive optical microstructure includes performing laser ablation of the substantially opaque layer by directing a laser beam onto said layer in a pattern corresponding with the array of discrete elements using a micro-mirror array.

In a further aspect, the present invention provides a method of producing a security document or article including a substrate transparent to at least visible light and a diffractive optical microstructure, wherein the diffractive optical microstructure is formed by mechanical ablation of a substantially opaque layer formed on a surface of the substrate.

In another aspect, the present invention provides a method of producing a security document or article including a substrate transparent to at least visible light and a diffractive optical microstructure, wherein the diffractive optical microstructure is formed by electrochemical mechanical ablation machining of a substantially opaque metallic layer formed on a surface of the substrate.

Further preferred features and advantages of the present invention will be apparent to those skilled in the art from the following description of preferred embodiments of the invention. It will be understood, however, that the preferred embodiments are not limiting of the scope of the invention as defined in any of the preceding statements, or in the claims appended hereto. In particular, it will be apparent that methods and features of the preferred embodiments may be combined in a variety of alternative arrangements within the scope of the present invention.

### BRIEF DESCRIPTION OF THE DRAWINGS

Preferred embodiments of the invention are described with reference to the accompanying drawings, in which:

FIG. 1 is a plan view of an identification card in accordance with an embodiment of the invention;

FIG. 2 is a schematic section on the line II-II of FIG. 1;

FIG. 3 illustrates an apparatus for performing a method of direct laser scanning using an XY galvanometer according to an embodiment of the invention;

FIG. 4 illustrates an apparatus for performing a method of direct laser scanning using a CNC stage according to an embodiment of the invention;

FIG. 5 illustrates an example of pixel marking of a substrate according to an embodiment of the invention;

FIG. 6 illustrates an example of vector scanning of a substrate according to an embodiment of the invention;

FIG. 7 illustrates example of sub-region masks for a method of scanning mask ablation according to an embodiment of the invention;

FIG. 8 illustrates apparatus for performing a method of scanning mask ablation according to an embodiment of the invention;

FIG. 9 illustrates apparatus for performing a method of direct imaging using a micro-mirror array according to an embodiment of the invention;

FIG. 10 illustrates apparatus for performing a method of direct CNC machining according to an embodiment of the invention; and

FIG. 11 illustrates apparatus for performing a method of electro-chemical machining according to an embodiment of the invention.

### DETAILED DESCRIPTION OF PREFERRED EMBODIMENTS

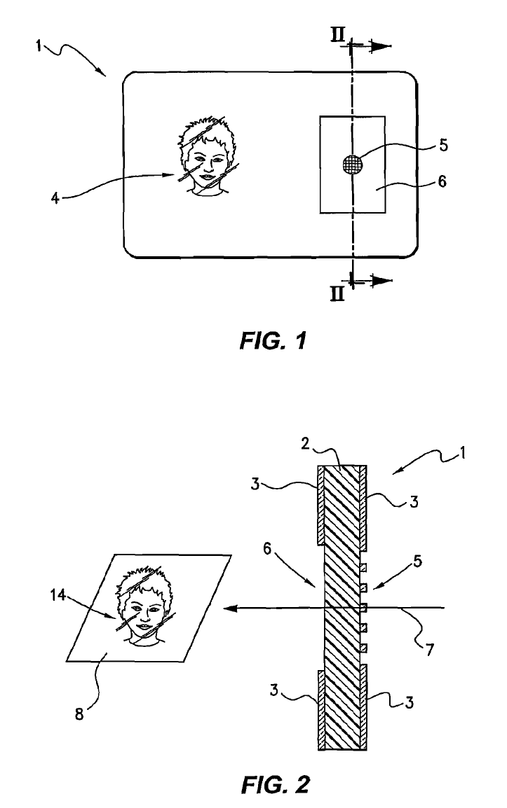

Referring to FIGS. 1 and 2 there is shown a security document in the form of an identification card 1 incorporating a personalised diffractive optical element 5 in accordance with an embodiment of the invention. The identification card 1 is formed from a transparent substrate 2 of polymeric material such as a laminate including at least one layer of biaxially oriented polypropylene. One or more opacifying layers 3 are applied to opposite surfaces of the substrate 2 in such a manner as to form a transparent window 6 in an area of one side of the substrate 2 which is uncovered by the opacifying layers 3. The personalised diffractive optical element 5 is provided on the side of the substrate opposed to the transparent window 6.

In one embodiment, the opacifying layers 3 may be formed from a pigmented coating containing titanium dioxide, and information, such as the card number, and/or the name of the card holder may be printed and/or embossed on the opacifying layers. As shown in FIG. 1 a photograph 4 of the card holder is also provided on the opacified portion 9 of the card 1.

As shown in FIG. 2, the personalised diffractive optical element 5 is a diffractive microstructure in the form of a numerical-type diffractive optical element (DOE) which when illuminated by a beam of substantially collimated light 7, eg from a point light source or laser, generates an interference pattern that produces a projected image 14 in a reconstruction plane that is visible when a viewing surface, such as a screen 8 is located in the reconstruction plane. The projected image 14 shown in FIG. 2 is an image of the card holder corresponding to the photograph 4 of the card holder on the opacified portion 9 of the card 1. Thus, in the event of tampering with the card to remove, alter or replace the photograph 4 of the card holder, it is possible to detect that the card has been tampered with by comparing the projected image 14 with the photograph 14 on the card itself.

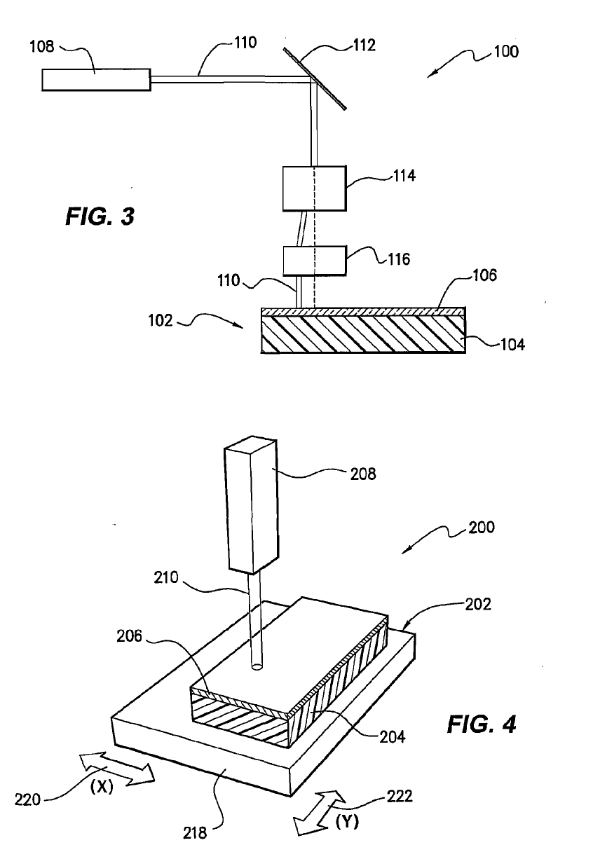

FIGS. 1 and 2 illustrate a personalised diffractive optical element 5 comprising a plurality of apertures formed in the opacifying layer 3 on one surface of the substrate 2 within a transparent window 6 formed on the opposing surface. It will be appreciated that this result may be achieved by any one of a variety of different methods. For example, the opacifying layer 3 may be extended on at least one surface of the substrate 2 to cover the window region 6, or an additional opacifying layer may be applied to at least one surface of the substrate 2 within the window 6, and a transmissive diffractive optical microstructure may then be formed by ablation of apertures within the opacifying layer. Alternatively or additionally, further layers may be applied to the substrate 2, and a personalised diffractive optical microstructure may be formed by ablation of internal layers thereby formed within the structure of the security document or other article. The particular embodiment 1 illustrated in FIGS. 1 and 2 should therefore not be considered to be limiting of the invention in any respect, and in particular it will be appreciated that the various methods of forming personalised diffractive optical microstructures described hereafter with reference to FIGS. 3 to 11 may be used to form a variety of alternative structures.

Referring to FIG. 3, there is shown an apparatus 100 for performing a method of direct laser scanning using an XY galvanometer according to an embodiment of the invention. As illustrated in FIG. 3, a security document or other article 102 includes a substrate 104, transparent at least to visible light, upon one surface of which is disposed a layer 106, which may be, for example, an opacifying layer consisting of or including a suitable pigmented ink. For convenience, throughout this description target objects of this type (ie having a transparent substrate and a layer disposed upon at least one surface thereof) are described. It is to be understood that such target objects are exemplary only, and that the invention in its various forms may act upon targets having other structures. For example, a plurality of layers may be applied to the substrate 104, and methods according to various embodiments of the invention may be used to ablate internal layers, ie layers other than the surface layers, within the resulting structure. It will therefore be understood that references within this specification to layers disposed upon a surface of a substrate encompass layers applied directly to a surface of the substrate, or to additional layers subsequently applied, and include surface layers and internal layers of such laminated structures. Furthermore, the target object eg 102 may be a security document or similar article, or it may be a mask intended to be used in a laser writing process for production of a security document or article bearing a personalised diffractive optical microstructure.

The purpose of the apparatus 100 is to form an individually personalised diffractive optical microstructure on the surface of the security document or other article 102 by ablating regions of the surface layer 106. The apparatus 100 includes a laser source 108, which includes a laser and other necessary optics for generating a suitable output laser beam 110 for the purposes of ablating the surface layer 106. As illustrated in FIG. 3, a mirror 112 is used to direct the laser beam 110 by XY galvanometer 114 and telecentric optics 116 onto the surface of the article 102. The function of the XY galvanometer 114 is to deflect the laser beam 110 under electronic control, while the telecentric optics 116 ensure that the deflected beam results in a corresponding undistorted spot on the surface layer 106 of the article 102. Accordingly, the telecentric scanning head arrangement 114, 116 may be used to direct the laser beam 110 to any desired position on the surface of the article 102 located generally beneath the scanning head.

According to presently preferred embodiments of the arrangement 100, the laser source 108 may include a frequency tripled or quadrupled Nd:YAG laser system, which when combined with a suitable telecentric scanning arrangement 114, 116 is capable of directing laser light onto the surface layer 106 of article 102 having a spot size of approximately 7 microns, which is sufficient for producing a diffractive optical microstructure by laser ablation of the surface layer 106.

FIG. 4 illustrates an alternative apparatus for performing direct laser scanning over the surface of an article 202 including a substrate 204 and surface layer 206, using a computer numerical control (CNC) stage 218. The apparatus 200 includes a laser source 208, which generates a laser beam output 210. As shown in FIG. 4, the output of laser source 208 is directly targeted onto the surface layer 206 of article 202. The article 202 is secured to CNC stage 218, which is operable under computer control to move along two orthogonal axes, as represented by the bidirectional arrows 220, 222 indicating movement along the X and Y cartesian coordinates respectively.

An advantage of the apparatus 200 based upon a CNC stage over the apparatus 100 based upon an XY galvanometer is that the laser source 208 may be a more readily available frequency doubled Nd:YAG laser. However, the CNC stage is slower in use, due to the requirement for mechanical movement of the article 202, as opposed to the purely optical beam movement facilitated by the XY galvanometer arrangement 100.

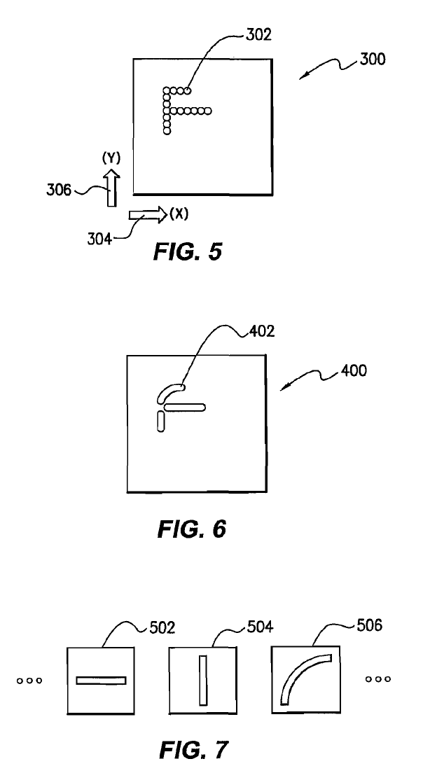

Either one of the arrangements 100, 200 may be used for pixel and/or vector marking of the surface layer 106, 206 of the articles 102, 202, as illustrated schematically in FIGS. 5 and 6. FIG. 5 shows an example of pixel marking of a substrate 300, whereas FIG. 6 illustrates an example of vector scanning of a substrate 400. In the process of pixel marking, the laser beam 110, 210 is directed towards a desired XY position on the substrate 300, as illustrated by the conventional cartesian axes 304, 306. Once the beam has been directed towards a location on the surface layer 106 which is to be ablated for the purposes of forming a diffractive optical microstructure, the laser source, 108, 208 may be fired in order to effect the ablation of the surface layer 106. Accordingly, the desired structure is formed on the surface layer 106, 206 by ablation of individual pixels, for example pixel 302 illustrated in FIG. 5.

An example of vector scanning of a substrate 400 is illustrated in FIG. 6. Vector scanning provides an alternative method of forming diffractive optical microstructures which has certain advantages over the pixel marking method. Whereas pixel marking involves defining the desired diffractive optical microstructure as a two dimensional field of predetermined dimensions, and sub-dividing the field into an array of discrete elements or pixels, vector scanning involves representing the desired diffractive optical microstructure as a plurality of narrow tracks. Each such track is sufficiently narrow to cause diffraction of laser light passing therethrough. It will be understood that the pixelation of a diffractive optical microstructure mask image is a product of the method by which it is calculated. However, it will be appreciated that diffraction is more generally the bending of light at a pin hole or a slit, and accordingly that a diffractive optical microstructure mask may be thought of as consisting of a series of narrow tracks which are generalisations of linear slits. The shape of the tracks will determine the pattern in which light passing therethrough is diffracted, and the width of the track will determine the angle of diffraction. Advantageously, masks consisting of tracks of 20 to 25 microns in width may be used to produce images having effective pixel sizes of 5 to 10 microns. Accordingly, vector scanning may be used to generate masks using lasers having a larger spot size of 20 to 25 microns to achieve a final effect that is equivalent to a 10 micron pixel size image.

For example, FIG. 6 illustrates the surface of a substrate 400 in which vector tracks eg 402, have been ablated. This may be achieved using the apparatus of either FIG. 3 or FIG. 4 by first directing the laser beam 110, 210 onto the point of the surface layer 106 at which the desired track commences, activating the laser 108, 208, and then scanning the location of the laser beam on the surface layer 106 using XY galvanometer 114 or CNC stage 218 in order to form the desired track, eg 402. The required tracks to be written may be determined by first generating the required personalised diffractive optical microstructure mask image, and then converting this mask image into a corresponding plurality of vectors. Image analysis techniques known in the art may be used to perform this conversion digitally based upon a bitmap image of the diffractive optical microstructure mask.

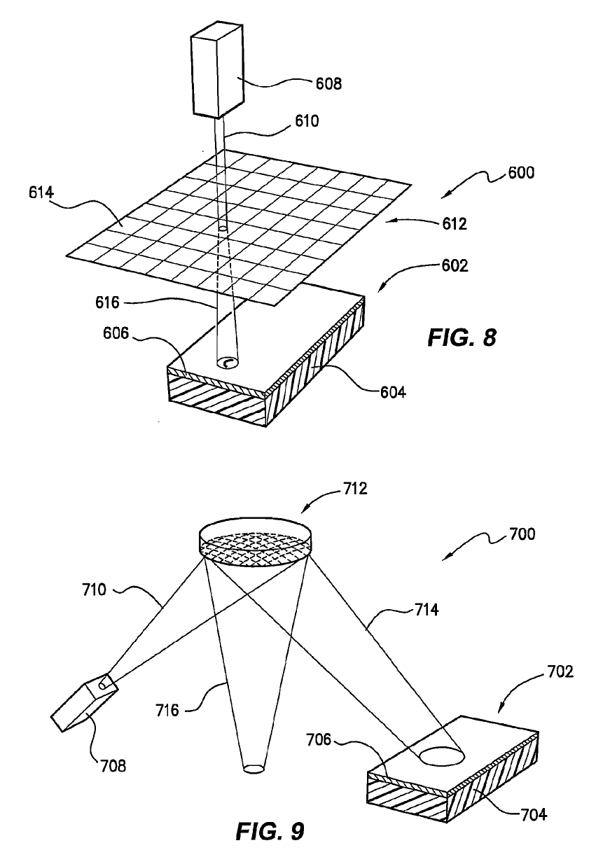

While the apparatus 100, 200 and corresponding methods, may be used to effectively form any desired individually personalised diffractive optical microstructure in the surface layers 106, 206 of corresponding articles 102, 202, it is generally desirable to provide means and methods that may further accelerate the writing process. This is particularly so for producing individually personalised structures, because the overall rate of production of security documents for other articles will be limited by the rate at which the personalised diffractive optical elements can be formed on the finished articles. Accordingly, FIGS. 7 and 8 illustrate a further embodiment of the present invention which may enable more rapid creation of a diffractive optical microstructures.

According to the further method illustrated by FIGS. 7 and 8, a mask pattern for a diffractive optical microstructure is divided into sub-regions, each of which corresponds with a group of pixels in an overall mask image. For example, each sub-region may represent a square or rectangular region of 10 to 20 by 10 to 20 pixels in dimensions. The corresponding portion of the mask image may then be approximated by one of a predetermined number of sub-masks, each of which defines a fixed graphical form, for example, a curve, a vertical line, a horizontal line, or a fine at any other arbitrary angle. FIG. 7 illustrates three examples representative of such predetermined sub-masks, specifically horizontal line 502, vertical line 504, and curved line 506.

Once the overall desired microstructure has been broken down into the separate sub-regions, an apparatus such as the arrangement 600 may be used to ablate corresponding regions of the surface layer 606 of article 602 in accordance with the following description.

The apparatus 600 further includes a laser source 608 which generates a beam 610. A mask plate 612, which may be, for example, a quartz mask plate, consists of an array of predefined sub-masks, eg 614. The laser source 608, the mask plates 612, and/or the target article 602 are positionable under computer control such that the laser beam 610 may be fired through any one of the predetermined sub masks onto a desired sub-region of the surface layer 606, in order to perform ablation in accordance with the shape of the sub-mask. Accordingly, the desired diffractive optical microstructure may be constructed, in the manner of a jigsaw, using sub units selected from the predetermined set of masks, eg 614, that are much larger than a single pixel. This may considerably accelerate the process of creation of the diffractive optical microstructure. For example, if the microstructure image consists of around 4 to 16 million pixels, the total number of laser shots required may be reduced from this value to as few as 20,000, corresponding with a 100 second creation time at a firing rate of 200 Hz. Furthermore, this technique may be carried out using a diffractive mask and a wider choice of lasers, including excimer lasers, Nd:YAG lasers, CO₂ lasers and so forth.

FIG. 9 illustrates an apparatus 700 for performing a method of direct imaging using a micro-mirror array 712 according to yet another embodiment of the invention. In accordance with the arrangement 700, a laser source 708 generates a beam 710 which is directed onto micro mirror array 712. The laser 708 may be, for example, an excimer layer.

The array 712 includes a large number, and possibly millions, of small mirrors which are individually controllable such that the reflective surface may be directed at a desired angle relative to the laser source 708 and the target article 702.

In accordance with the embodiment of the invention, the mirrors of array 712 are controlled such that desired components of the beam 710 are directed to the surface layer 706 of the article 702 as a patterned beam of light 714. This patterned beam thereby ablates the surface layer 706 to form a desired diffractive optical microstructure thereon. The remaining mirrors are controlled so as to direct undesired portions of the incident beam 710 into beam 716, which is directed away from the target article 702.

It will be appreciated by those skilled in the art that the misdirected beam 716 bears a pattern which is the inverse of that borne by the beam 714, and that this beam, if directed onto a similar surface layer to that of the article 702 would therefore form an inverse diffractive optical microstructure having properties identical to those of the positive. Accordingly, an advantage of the apparatus 700 illustrated in FIG. 9 is that it could be used to simultaneously create two articles bearing corresponding personalised diffractive optical microstructures.

A further variation of the technique is exemplified by the apparatus 700 would use multiple, smaller beams each directed onto a simpler micro-mirror array in order to generate the desired diffractive optical microstructure pattern by interference between the beams reflected from the arrays.

As has previously been suggested, all of the foregoing methods and apparatus may be used either to directly ablate the surface of a security document or other article, or to ablate a surface layer of a substrate in order to produce a mask which could subsequently be used for creation of a personalised diffractive optical microstructure in a finished article using conventional mask ablation techniques. Indeed, a particular advantage of this approach is that a mask may be generated prior to the security document or other article becoming available for surface ablation. This would enable other features of the finished security document or article to be formed simultaneously with the formation of a mask for the formation of a personalised diffractive optical microstructure. Such a technique of parallel manufacturing would further increase throughput of production of personalised security documents or other articles.

In addition, a mask could be manufactured to a somewhat larger scale than the desired diffractive optical microstructure image. For example, a four-times scale image would enable the mask to utilise 15 micron pixels or 30 micron tracks, and to be generated upon materials having a reduced cost such as aluminium coated polypropylene. The smaller finished diffractive optical microstructure would subsequently be formed using known magnifying optical arrangements, wherein the optical power density on the surface of the mask is reduced relative to the power density applied to the surface of the security document or article after passage through the imaging optics. This enables lasers having a larger spot size to be utilised, and materials having a lower tolerance to optical power to be used for the masks. The reduced incident power density may increase the durability and corresponding lifetime of the masks.

In addition to the foregoing techniques, a photolithography technique could be employed for manufacture of masks.

Following use of the mask in production of the security document or other article, the mask may either by discarded or stored in a library for future reissues or other reference uses.

One or more libraries of predetermined masks may also be employed to form unique and/or otherwise personalised diffractive optical microstructures by a superposition method. According to this method, two or more masks are selected, each of which corresponds with a predetermined diffractive element. A substrate, or a layer applied thereto, is then exposed to laser radiation directed through each of the selected masks, either simultaneously or sequentially, in order to form a diffractive optical microstructure representing substantially a superposition of the diffractive elements corresponding with each of the selected masks. For example, at least two sets of masks representing alphanumeric character images could be manufactured, wherein a first set represents characters projected into the left side of a resulting image field, and a second set represents characters projected into the right side of a resulting image field. A customised diffractive optical microstructure is then formed by ablating the substrate, or layer applied thereto, such as through directing two laser pulses through each of the two masks onto the same region of the target. When suitably illuminated, both characters will be projected onto the corresponding image plane. This method may be used to produce personalised images, such as images of an individual's initials or other personal information. Although the quality of the superimposed diffractive optical microstructure, and the resulting images, may decrease with increasing number of constituent diffractive elements, for relatively small numbers of exposures the diffractive optical microstructures and resulting images may remain of acceptable quality.

While methods are described above, with reference to FIGS. 3 to 9, for forming apertures by laser ablation of a substantially opaque layer, in alternative embodiments similar apparatus and processes may be applied to form apertures by laser-writing of opaque regions within a transparent layer including a suitable photosensitive additive. For example, a transparent layer may be provided including an additive which is rendered substantially opaque upon exposure to suitable laser radiation. It may then be possible to form a substantially opaque layer including transparent apertures by exposure of regions of the layer corresponding with the opaque portions of the desired diffractive optical microstructure, rather than by exposure of regions corresponding with the transparent regions (ie apertures) of the structure. As will be appreciated, this may be achieved using the above-described apparatus and methods by utilising an inverse exposure pattern to that employed for the formation of apertures within an opaque layer.

According to further embodiments of the invention, masks and/or personalised diffractive optical microstructures may be produced using suitable printing techniques. In practice, a suitable printing technique should be capable of providing a true resolution of around 5,000 dpi, in order to produce pixels having dimensions on the order of 5 microns. It should be appreciated that the specified resolution of many printers commonly used relates to the density of ink spots printed, and not to the size of the spots which may be somewhat larger then the claimed resolution. In some cases, therefore, a printer specified for a resolution of 5,000 dpi would not be suitable for the production of a diffractive optical microstructure mask. However, an inkjet, laser printing and/or digital printing system could be used so long as it was capable of producing sufficiently small ink or toner spots.

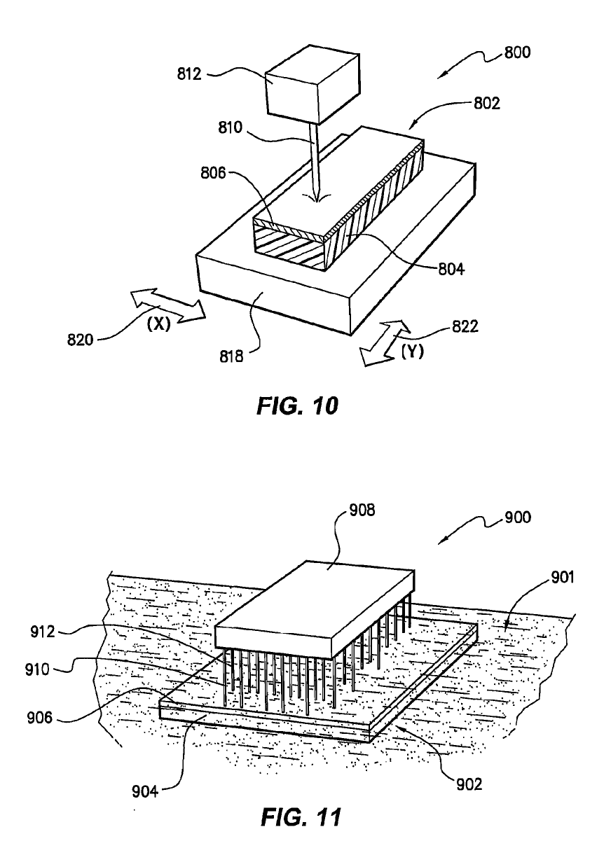

FIG. 10 illustrates an apparatus 800 for performing a method of direct CNC machining of a surface layer 806 of an article 802. The apparatus 800 includes a mechanical support 802 to which is a fixed and extensible needle 810. The article 802 is mounted on CNC stage 818, which may be translated along the two axes X and Y 820, 822. The needle 810 may be extended to mechanically ablate a corresponding spot on the surface layer 806 disposed on substrate 804 of the article 802. In a like manner to the optical apparatus 100, 200, the arrangement 800 may be used to ablate pixels and/or tracks in the surface layer 806 of the article 802.

FIG. 11 illustrates an apparatus 900 for performing a method of electro-chemical machining of a mask 902 consisting of a transparent substrate 904 and surface layer 906. The surface layer 906 is a metallic layer, and the substrate 904 may be quartz or a suitable polymer.

Electro-chemical machining involves the removal of metal using an electrical current in a suitable salt solution. In the arrangement 900, the mask 902 is immersed within a salt bath 901. A specialised electrode 908 includes a two dimensional array of retractable and/or extensible pins, eg 910, 912, which may be extended and/or retracted in a desired pattern of a contact with the metalisation layer 906.

By applying a current to the electrode 908, selected pixels may thereby be removed using the electro-chemical effect from the metalisation layer 906. This technique may therefore be used to create a desired mask for use in laser writing of the personalised diffractive optical microstructure.

It will be appreciated from the foregoing description that the present invention encompasses various embodiments of methods and apparatus suitable for producing customised diffractive optical microstructures enabling the fabrication of individually a customised security documents or other articles. The invention encompasses techniques that are sufficiently practical, fast and cost effective to be used in the production of personalised security documents. Accordingly, the invention overcomes or mitigates problems of the prior art, whereby it was generally impractical to mass-produce diffractive optical microstructures that are required to be different on each security document or other article produced.

It will be understood, however, that while the various methods described herein have particular application to the production of personalised security documents or articles, they may equally be utilised in the manufacture of non-personalised documents or articles, such as those bearing a common diffractive structure representative of, for example, a document issuer.

It will also be appreciated that various modifications and/or alterations that would be apparent to a person of skill in the art may be made without departing from the scope of the invention. For example, the apparatus and methods described herein may be combined in various ways for the production of masks and/or diffractive optical microstructures, and in this respect each specific embodiment should be considered to be exemplary only. The overall scope of the invention is as defined in the claims appended hereto.

1-41. (canceled)

42. A method of producing a personalised security document or article, including the steps of:
providing a substrate which is transparent at least to visible light; and
forming a diffractive optical microstructure comprising a plurality of apertures formed in a substantially opaque layer disposed on a surface of the substrate,
wherein the diffractive optical microstructure is formed such that when suitably illuminated a projected image is generated which is unique to a particular individual.

43. The method of claim 42 wherein the step of forming the diffractive optical microstructure includes applying at least one opacifying layer to the surface of the substrate, and wherein the diffractive optical microstructure is formed by ablation of said layer.

44. The method of claim 42 wherein the step of forming a diffractive optical microstructure includes ablating the opaque layer disposed on the surface of the substrate.

45. The method of claim 43 wherein the step of forming a diffractive optical microstructure includes performing laser ablation of the opacifying layer.

46. The method of claim 42 including the further steps of:
representing the diffractive optical microstructure as a two-dimensional field having predetermined dimensions;
subdividing the two-dimensional field into an array of discrete elements; and
determining the content of each discrete element of the field in order to form an image of the diffractive optical microstructure.

47. A method according to claim 42 including the step of representing the diffractive optical microstructure as a plurality of narrow tracks, and said step of representing the diffractive optical microstructure as a plurality of narrow tracks includes:
generating a diffractive optical microstructure mask image; and
converting the diffractive optical microstructure mask image into a plurality of vectors corresponding with the narrow tracks.

48. The method of claim 42 including the step of representing the diffractive optical microstructure as a tiled array of square or rectangular sub-regions, and including the step of approximating each said sub-region by one of a pre-determined plurality of masks, each of which defines a fixed graphical form.

49. The method of claim 42 wherein the step of forming a diffractive optical microstructure includes directing a laser beam onto the opaque layer using a micro-minor array, and setting the angle of each mirror of said array so as to direct light either onto or away from the opaque layer, whereby a pattern of illumination is generated corresponding with the diffractive optical microstructure to be formed thereon.

50. The method of claim 42 including the step of forming a personalised mask corresponding with the diffractive optical microstructure, and wherein the step of forming the diffractive optical microstructure includes exposing the opaque layer to laser radiation directed through the mask so as to form corresponding apertures therein.

51. The method of claim 42 wherein the step of forming a diffractive optical microstructure includes printing, using a suitable substantially opaque ink, dye or toner, the microstructure onto a suitable transparent substrate.

52. The method of claim 42 wherein the step of forming a diffractive optical microstructure is performed using a mechanical process to form apertures in the opaque layer, and the mechanical process includes providing a computer numerical control stage fitted with one or more mechanical ablating structures, and using said structures to selectively physically remove portions of the opaque layer.

53. The method of claim 42 wherein the substantially opaque layer is a metallic layer, and the step of forming a diffractive optical microstructure includes performing electro-chemical machining of the metallic layer, and including providing a reconfigurable electrode formed as an array of individual electrode elements selectively extensible or retractable to generate a desired diffractive optical microstructure pattern, and using said reconfigurable electrode to image a pattern corresponding with the diffractive optical microstructure onto said metallic layer.

54. The method of claim 42, including the step of providing at least two masks, each of which corresponds with a predetermined diffractive element, and wherein the step of forming the diffractive optical microstructure includes exposing the opaque layer to laser radiation directed through each one of said masks.

55. A personalised security document or article which includes
a substrate which is transparent at least to visible light; and
a diffractive optical microstructure formed in a substantially opaque layer disposed on a surface of the substrate using a method according to claim 42.

56. A personalised security document or article which includes:
a substrate which is transparent at least to visible light; and
a diffractive optical microstructure comprising a plurality of apertures formed in a substantially opaque layer disposed on a surface of the substrate,
wherein the diffractive optical microstructure is formed such that when suitably illuminated an image is generated which is unique to a particular individual.

57. A method of producing a security document or article including a substrate transparent to at least visible light and a diffractive optical microstructure, the method including the steps of:
representing the diffractive optical microstructure as a plurality of narrow tracks, and
forming the diffractive optical microstructure in a substantially opaque layer disposed on a surface of the substrate, by forming apertures in said layer in accordance with the plurality of narrow tracks.

58. A method of producing a security document or article including a substrate transparent to at least visible light and a diffractive optical microstructure, the method including the steps of:
representing the diffractive optical microstructure as a tiled array of square or rectangular sub-regions; and
forming the diffractive optical microstructure in a substantially opaque layer disposed on a surface of the substrate by forming apertures in said layer corresponding with said array of square or rectangular sub-regions.

59. A method of producing a security document or article including a substrate transparent to at least visible light and a diffractive optical microstructure, the method including the steps of:
representing the diffractive optical microstructure as a two-dimensional array of discrete elements; and
forming the diffractive optical microstructure by ablation of apertures in a substantially opaque layer disposed on a surface of the substrate,
wherein the step of forming the diffractive optical microstructure includes performing laser ablation of the substantially opaque layer by directing a laser beam onto said layer in a pattern corresponding with the array of discrete elements using a micro-mirror array.

60. A method of producing a security document or article including a substrate transparent to at least visible light and a diffractive optical microstructure, wherein the diffractive optical microstructure is formed by mechanical ablation of a substantially opaque layer formed on a surface of the substrate.

61. A method of producing a security document or article including a substrate transparent to at least visible light and a diffractive optical microstructure, wherein the diffractive optical microstructure is formed by electrochemical machining of a substantially opaque metallic layer formed on a surface of the substrate.
